(19) United States
(12) Patent Application Publication
(10) Pub. No.: US 2026/0066334 A1
(43) Pub. Date: Mar. 5, 2026

(54) LITHIUM-ION SECONDARY BATTERY, AND METHOD OF PRODUCING LITHIUM-ION SECONDARY BATTERY

(71) Applicant: TOYOTA JIDOSHA KABUSHIKI KAISHA, Toyota-shi (JP)

(72) Inventors: Yosuke SHIMURA, Nagakute-shi (JP); Tomofumi HIRUKAWA, Miyoshi-shi (JP); Hiroshi KAWASAKI, Toyota-shi (JP)

(73) Assignee: TOYOTA JIDOSHA KABUSHIKI KAISHA, Toyota-shi (JP)

(21) Appl. No.: 19/192,614

(22) Filed: Apr. 29, 2025

(30) Foreign Application Priority Data
Sep. 5, 2024 (JP) 2024-153268

(51) Int. Cl. H01M 10/0525; H01M 4/02; H01M 4/04; H01M 4/1391; H01M 4/525; H01M 4/62; H01M 4/66

(52) U.S. Cl. CPC H01M 10/0525; H01M 4/0404; H01M 4/1391; H01M 4/525; H01M 4/622; H01M 4/661; H01M 2004/021

(57) ABSTRACT

A lithium-ion secondary battery is a lithium-ion secondary battery including an electrode active material layer, in which the electrode active material layer contains an electrode active material and a binder, the average pore diameter of the electrode active material layer is 1.00 μm or less, and the porosity of the electrode active material layer is 8.8% or less.

### CROSS-REFERENCE TO RELATED APPLICATION

This application claims priority to Japanese Patent Application No. 2024-153268 filed on Sep. 5, 2024. The disclosure of the above-identified application, including the specification, drawings, and claims, is incorporated by reference herein in its entirety.

### BACKGROUND

### 1. Technical Field

The present disclosure relates to a lithium-ion secondary battery, and a method of producing a lithium-ion secondary battery.

### 2. Description of Related Art

As a lamination method for an electrode active material layer included in a lithium-ion secondary battery, there is generally known a lamination method of generating an electrode composite material slurry by adding a solvent to the components of the electrode active material layer, and then applying and drying the electrode composite material slurry.

However, when a binding agent (binder) contained in the electrode composite material slurry is heated and dried, so-called binder migration by which the binding agent moves from an adhesive surface to a front surface occurs. When the binder migration occurs, the electrode active material layer is easily peeled, which results in a decrease in battery performance. In response, there are various disclosures for restraining the decrease in peeling strength.

For example, Japanese Unexamined Patent Application Publication No. 2012-134023 (JP 2012-134023 A) discloses a lithium-ion secondary battery including a wound electrode group that is formed by winding a positive electrode, a negative electrode, and a separator sandwiched between the positive electrode and the negative electrode. Each of the positive electrode and the negative electrode contains a current collector and an electrode mixture layer that is provided on a surface of the current collector. The electrode mixture layer contained in at least one of the positive electrode and the negative electrode contains a binder resin and an active material. The active material is composed of an active material particle group having a plurality of peaks in a particle size distribution. The active material particle group is composed of a compound having a single composition. It is described that the lithium-ion secondary battery in JP 2012-134023 A has a high reliability and a high output power.

### SUMMARY

In a step of forming the electrode active material layer, it is required to shorten the drying time for the electrode composite material slurry applied on the current collector layer. However, in the case of the high-speed drying of the electrode composite material slurry at a high temperature, the amount of the occurrence of the binder migration increases, and the binding force between the electrode active material layer and the current collector layer decreases.

Hence, the present disclosure has an object to provide a lithium-ion secondary battery including an electrode active material layer that has a high binding force for the current collector layer, particularly, an electrode active material layer that has a high binding force for the current collector layer even when the electrode active material layer is produced by the high-speed drying of the electrode composite material slurry at a high temperature.

The present disclosure achieves the above object by the following means.

### Aspect 1

A lithium-ion secondary battery including an electrode active material layer, wherein: the electrode active material layer contains an electrode active material and a binder; an average pore diameter of the electrode active material layer is 1.00 μm or less; and a porosity of the electrode active material layer is 8.8% or less.

### Aspect 2

The lithium-ion secondary battery according to aspect 1, wherein:
the electrode active material layer contains, as the electrode active material, two or more kinds of electrode active materials having different average particle diameters; and
an average particle diameter of an electrode active material having a largest average particle diameter is greater than or equal to five times an average particle diameter of an electrode active material having a smallest average particle diameter.

### Aspect 3

The lithium-ion secondary battery according to aspect 1 or 2, wherein the average pore diameter of the electrode active material layer is 0.30 μm or more, and/or the porosity of the electrode active material layer is 0.5% or more.

### Aspect 4

A method of producing a lithium-ion secondary battery including an electrode active material layer, the method comprising:
generating an electrode composite material by mixing two or more kinds of electrode active materials having different average particle diameters and a binder having an average particle diameter of 0.30 μm or more; and
producing the electrode active material layer by shaping the electrode composite material, wherein
an average particle diameter of an electrode active material having a largest average particle diameter is greater than or equal to five times an average particle diameter of an electrode active material having a smallest average particle diameter.

### Aspect 5

The method according to aspect 4, further comprising drying the electrode composite material at a temperature of 100° C. or higher.

With the present disclosure, it is possible to provide a lithium-ion secondary battery including an electrode active material layer that has a high binding force for the current collector layer, particularly, an electrode active material layer that has a high binding force for the current collector layer even when the electrode active material layer is produced by the high-speed drying of the electrode composite material slurry at a high temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view for describing binder migration in an electrode active material layer; and

FIG. 1B is a schematic view for describing the binder migration in the electrode active material layer.

### DETAILED DESCRIPTION OF EMBODIMENTS

### Lithium-Ion Secondary Battery

A lithium-ion secondary battery in the present disclosure is a lithium-ion secondary battery including an electrode active material layer, in which the electrode active material layer contains an electrode active material and a binder, the average pore diameter of the electrode active material layer is 1.00 μm or less, and the porosity of the electrode active material layer is 8.8% or less.

With the present disclosure, it is possible to provide a lithium-ion secondary battery including an electrode active material layer that has a high binding force for a current collector layer, particularly, an electrode active material layer that has a high binding force for the current collector layer even when the electrode active material layer is produced by the high-speed drying of the electrode composite material slurry at a high temperature.

The disclosers have found that there is a high binding force between the electrode active material layer and the current collector layer in the case where the pore diameter of the electrode active material layer is 1.00 μm or less and the porosity is 8.8% or less. Although not limited to any theory, it is thought that a sufficiently small pore diameter and porosity make it hard for the binder to move from a binding surface between the electrode active material layer and the current collector layer to the opposite surface side of the binding surface at the time of the high-temperature drying and a large amount of binder remains on the binding surface side, so that there is a high binding force between the electrode active material layer and the current collector layer.

Furthermore, the disclosers have found that the above pore diameter and the above porosity are met by using, in the electrode active material layer, an electrode active material mixture in which the average particle diameter of an electrode active material having the largest average particle diameter is greater than or equal to five times the average particle diameter of an electrode active material having the smallest average particle diameter.

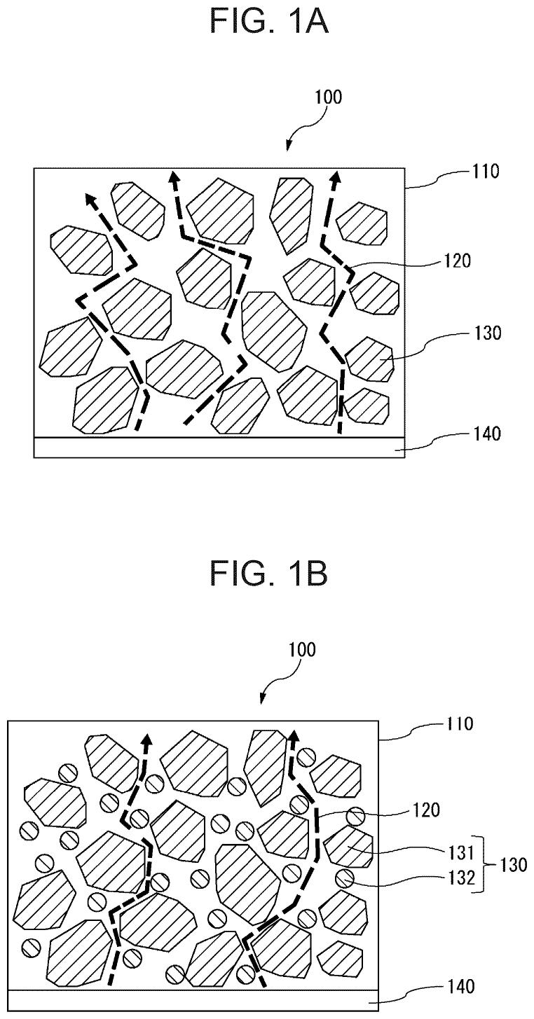

Specifically, for example, as shown in FIG. 1A, an electrode body 100 includes an electrode active material layer 110 and a current collector layer 140. The electrode active material layer 110 is formed by adding a solvent to an electrode composite material containing an electrode active material 130 and a binding agent (not illustrated), to generate an electrode composite material slurry, applying the electrode composite material slurry on a current collector layer 140, and thereafter performing drying. Particularly, in the case of high-temperature drying, binder migration easily occurs, and for example, the binding agent passes through a binder migration path 120 and moves from a current collector layer 140 side to a front surface side. Hence, as shown FIG. 1B, the electrode active material 130 contains two or more kinds of electrode active materials having different average particle diameters, and thereby, the pore diameter and porosity of the electrode active material layer 110 decrease. In the two or more kinds of electrode active materials having different average particle diameters, the average particle diameter of an electrode active material 131 having the largest average particle diameter is greater than or equal to five times the average particle diameter of an electrode active material 132 having the smallest average particle diameter. The decrease in the pore diameter and porosity of the electrode active material layer 110 narrows the binder migration path 120, makes it hard for the binder migration to occur, and increases the binding force between the electrode active material layer 110 and the current collector layer 140.

In the present disclosure, the “electrode composite material” means a composition that can compose the electrode active material layer by itself or by further containing another component. Further, in the present disclosure, the “electrode composite material slurry” means a slurry that contains a dispersion medium in addition to the “electrode composite material” and thereby can form the electrode active material layer by applying and drying.

Each constituent element of the present disclosure will be described below.

The lithium-ion secondary battery in the present disclosure includes the electrode active material layer. The lithium-ion secondary battery may include a positive electrode current collector layer, a negative electrode current collector layer, an electrolyte layer, and the like.

In the present disclosure, the lithium-ion secondary battery may be a liquid-state battery that contains an electrolytic solution as the electrolyte layer, or may be a solid-state battery that includes a solid electrolyte layer as the electrolyte layer. In the present disclosure, the “solid-state battery” means a battery in which at least a solid electrolyte is used as an electrolyte, and accordingly, in the solid-state battery, a combination of the solid electrolyte and a liquid electrolyte may be used as the electrolyte. Further, in the present disclosure, the solid-state battery may be an all-solid-state battery, that is, a battery in which only the solid electrolyte is used as the electrolyte.

### Electrode Active Material Layer

The electrode active material layer in the present disclosure contains the electrode active material and the binder. The electrode active material layer may optionally further contain a conduction aid, a solid electrolyte, and others. In addition, the electrode active material layer may contain various additive agents. The electrode active material layer may be a positive electrode active material layer, or may be a negative electrode active material layer.

The average pore diameter of the electrode active material layer is 1.00 μm or less. Since the average pore diameter is small, it is hard for the binder migration to occur. The average pore diameter may be 0.95 μm or less, 0.90 μm or less, or 0.85 μm or less. Further, it is preferable that the average pore diameter is 0.30 μm or more, 0.35 μm or more, 0.40 μm or more, 0.45 μm or more, or 0.50 μm or more, from the standpoint of ensuring rapid charging performance.

The porosity of the electrode active material layer is 8.8% or less. Since the porosity is small, it is hard for the binder migration to occur. The porosity may be 8.6% or less, 8.4% or less, 8.0% or less, or 7.5% or less. Further, it is preferable that the porosity is 0.5% or more, 0.6% or more, 0.7% or more, 0.8% or more, or 0.9% or more, from the standpoint of ensuring rapid charging performance.

The average pore diameter is measured by a mercury intrusion technique in which a mercury porosimeter is used, in accordance with JIS-R-1655. In a state where a sample is immersed in mercury in a vacuum, an even pressure is given, and the pressure is gradually raised. Then, mercury is pressed into pores in the order from pores having large diameters, and the accumulative volume of mercury increases. When all pores are finally filled with mercury, the accumulative volume reaches a measuring volume. The accumulative volume at this time is adopted as a pore volume, and a median size (D50) at the time point when mercury having a volume corresponding to a pore volume of 50% is pressed into pores is adopted as the average pore diameter. Further, the porosity is calculated from the above pore volume.

As the peeling strength characteristic between the electrode active material layer and the current collector layer, it is preferable that a peeling strength when drying is performed at 150° C. for 2 minutes is equal to a peeling strength when drying is performed at 50° C. for 20 minutes. The migration is restrained, and thereby, the high-speed drying becomes possible.

The peeling strength between the electrode active material layer and the current collector layer can be measured by fixing a test sample of the current collector layer on which the electrode active material layer is laminated, to a base member in a 90° peeling tester, and peeling the electrode active material layer from one end portion, in accordance with JIS-K-6854-1.

Respective contents of the electrode active material, conduction aid, solid electrolyte, and others in the electrode active material layer may be appropriately determined depending on an intended battery performance. For example, when all (all solid content) of the electrode active material layer is 100 mass %, the content of the electrode active material may be 40 mass % or more, 50 mass % or more, or 60 mass % or more, and may be 100 mass % or less, or 90 mass % or less.

The content of the binder is not particularly limited, and for example, may be 0.1 pts·mass or more, 0.2 pts·mass or more, 0.5 pts·mass or more, 1.0 pts·mass or more, or 2.0 pts·mass or more, and may be 5.0 pts·mass or less, 4.5 pts·mass or less, 4.0 pts·mass or less, 3.5 pts·mass or less, or 3.0 pts·mass or less, with respect to 100 pts·mass of the electrode active material.

### Electrode Active Material

The electrode active material layer may contain two or more kinds of electrode active materials having different average particle diameters, and the average particle diameter of an electrode active material having the largest average particle diameter may be greater than or equal to five times the average particle diameter of an electrode active material having the smallest average particle diameter.

The average particle diameter of the electrode active material having the largest average particle diameter is not particularly limited. For example, the average particle diameter of the electrode active material having the largest average particle diameter may be 5 nm or more, or 10 nm or more, and may be 500 μm or less, 100 μm or less, 50 μm or less, or 30 μm or less.

The average particle diameter of the electrode active material having the smallest average particle diameter is not particularly limited. For example, the average particle diameter of the electrode active material having the smallest average particle diameter may be 1 nm or more, 5 nm or more, or 10 nm or more, and may be 100 μm or less, 50 μm or less, or 30 μm or less.

The average particle diameter is a particle diameter (median size) at an integrated value of 50% in a volume-basis particle size distribution that is evaluated by a laser diffracting-scattering method.

The content of the electrode active material having the smallest average particle diameter may be adjusted in consideration of the average pore diameter and porosity of the electrode active material layer. For example, the content of the electrode active material having the smallest average particle diameter may be 20 pts·mass or more, 25 pts·mass or more, 30 pts·mass or more, 35 pts·mass or more, 40 pts·mass or more, 45 pts·mass or more, or 50 pts·mass or more, and may be 100 pts·mass or less, 90 pts·mass or less, 80 pts·mass or less, 70 pts·mass or less, or 60 pts·mass or less, with respect to 100 pts·mass of the electrode active material having the largest average particle diameter.

The material of the positive electrode active material is not particularly limited, as long as lithium ions can be stored and released. Examples of the positive electrode active material include lithium cobalt oxide (LiCoO₂), lithium nickel oxide (LiNiO₂), lithium manganese oxide (LiMn₂O₄), lithium nickel-cobalt-manganese oxide (NCM: LiCO_{1/3}Ni_{1/3}Mn_{1/3}O₂), lithium nickel-cobalt-aluminum oxide (LiNi_{0.8}(CoAl)_{0.2}O₂), and a different-element substitution Li—Mn spinel having a composition expressed as Li₁₊ₓMn_{2-x-y}M_{y}O₄ (M is one or more kinds of metal elements selected from Al, Mg, Co, Fe, Ni, and Zn), but are not limited to these.

The positive electrode active material, which is not particularly limited, may include a coated layer. The coated layer is a layer containing a substance that has a lithium-ion conduction performance, that has a low reactive property with the positive electrode active material and the solid electrolyte, and that makes it possible to maintain the shape of the coated layer without flowing even when making contact with the active material or the solid electrolyte. Specific examples of the material composing the coated layer include LiNbO₃, Li₄Ti₅O₁₂, and Li₃PO₄, but are not limited to these.

As the negative electrode active material, various substances each of which the electric potential (charge-discharge potential) at which lithium ions are stored and released is a base electric potential compared to the positive electrode active material can be employed. The material of the negative electrode active material is not particularly limited, and may be a metal lithium, or may be a material that can store and release metal ions such as lithium ions. Examples of the material that can store and release metal ions such as lithium ions include an alloyed negative electrode active material, a carbon material, and lithium titanate (Li₄Ti₅O₁₂), but are not limited to these.

Examples of the alloyed negative electrode active material, which are not particularly limited, include an Si-alloyed negative electrode active material and an Sn-alloyed negative electrode active material. Examples of the Si-alloyed negative electrode active material include silicon, silicon oxide, silicon carbide, silicon nitride, and a solid solution of these. Further, the Si-alloyed negative electrode active material can contain a metal element other than silicon, for example, Fe, Co, Sb, Bi, Pb, Ni, Cu, Zn, Ge, In, Sn, Ti, or the like. Examples of the Sn-alloyed negative electrode active material include tin, tin oxide, tin nitride, and a solid solution of these. Further, the Sn-alloyed negative electrode active material can contain a metal element other than tin, for example, Fe, Co, Sb, Bi, Pb, Ni, Cu, Zn, Ge, In, Ti, Si, or the like.

Examples of the carbon material, which are not particularly limited, include hard carbon, soft carbon, and graphite.

### Binder

The binder is not particularly limited, and for example, may be a material such as polyvinylidene fluoride (PVdF), butadiene rubber (BR), polytetrafluoroethylene (PTFE), and styrene-butadiene rubber (SBR). As the binder, only one kind may be used alone, or two or more kinds may be combined and used.

The average particle diameter of the binder may be 0.30 μm or more, 0.35 m or more, 0.40 μm or more, 0.45 μm or more, or 0.50 μm or more. Since the average particle diameter of the binder is large, it is hard for the binder migration to occur. Further, the average particle diameter of the binder nay be 3.00 μm or less, 2.00 μm or less, 1.50 μm or less, or 1.00 μm or less.

The average particle diameter means an average value of projected area circle corresponding diameters that are evaluated from a scanning electron microscope (SEM) image of a test piece obtained by drying only the binder.

### Conduction Aid

Examples of the conduction aid, which are not particularly limited, include vapor-grown carbon fiber (VGCF), acetylene black (AB), Ketjen black (KB), carbon nanotube (CNT), carbon nanofiber (CNF), and conductive carbon. The conduction aid may have a particle form or a fiber form, for example, and the size is not particularly limited. As the conduction aid, only one kind may be used alone, or two or more kinds may be combined and used.

### Solid Electrolyte

Examples of the material of the solid electrolyte, which are not particularly limited, include a sulfide solid electrolyte, an oxide solid electrolyte, and a polymer electrolyte.

Examples of the sulfide solid electrolyte include a sulfide-system amorphous solid electrolyte, a sulfide-system crystalline solid electrolyte, and an argyrodite solid electrolyte, but are limited to these. Specific examples of the sulfide solid electrolyte include Li₂S—P₂S₅(Li₇P₃S₁₁, Li₃PS₄, Li₈P₂S₉, and the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃Si₆, Li₁₀GeP₂S₁₂, and the like), LiI—Li₂S—P₂O₅, LiI—Li₃PO₄—P₂S₅, Li₇₋ₓPS₆₋ₓClₓ, and a combination of these, but are not limited to these.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), and a combination of these, but are not limited to these.

Each of the sulfide solid electrolyte and the oxide solid electrolyte may be glass, or may be crystallized glass (glass ceramic).

Examples of the polymer electrolyte include polyethylene oxide (PEO), polypropylene oxide (PPO), and a copolymer of these, but are not limited to these.

### Positive Electrode Current Collector Layer

The material that is used for the positive electrode current collector layer is not particularly limited, and a general positive electrode current collector for batteries can be appropriately employed. Examples of the material that is used for the positive electrode current collector layer include Cu, Ni, Cr, Au, Pt, Ag, Al, Fe, Ti, Zn, Co, and stainless steel, but are not limited to these. Further, the positive electrode current collector layer may include some kind of coat layer on a surface thereof, for the adjustment of the resistance, or other purposes. Further, the positive electrode current collector layer may be obtained by plating or depositing the above metal on a metal foil or a base material.

Examples of the form of the positive electrode current collector layer, which are not particularly limited, include a foil form, a plate form, and a mesh form. Among these forms, the foil form is preferable.

The thickness of the positive electrode current collector layer, which is particularly not limited, may be 0.1 μm or more, or 1 μm or more, and may be 1 mm or less, or 100 μm or less.

### Negative Electrode Current Collector Layer

The material that is used for the negative electrode current collector layer is not particularly limited, and a general negative electrode current collector for batteries can be appropriately employed. Examples of the material that is used for the negative electrode current collector layer include Cu, Ni, Cr, Au, Pt, Ag, Al, Fe, Ti, Zn, Co, stainless steel, and carbon sheet, but are not limited to these. The negative electrode current collector layer may include some kind of coat layer on a surface thereof, for the adjustment of the resistance, or other purposes.

Examples of the form of the negative electrode current collector layer, which are not particularly limited, include a foil form, a plate form, and a mesh form. Among these forms, the foil form is preferable.

The thickness of the negative electrode current collector layer, which is not particularly limited, may be 0.1 μm or more, or 1 μm or more, and may be 1 mm or less, or 100 μm or less.

### Electrolyte Layer-Solid Electrolyte Layer

The battery in the present disclosure may be a solid-state battery, that is, may include a solid electrolyte layer as the electrolyte layer. The solid electrolyte layer contains at least a solid electrolyte, and may contain a conduction aid, a binder, and others, as necessary.

As for the solid electrolyte, the conduction aid, and the binder, the above description about the electrode active material layer can be referred to.

The thickness of the solid electrolyte layer is not particularly limited. For example, the thickness of the solid electrolyte layer may be 0.1 μm or more, 1 μm or more, or m or more, and may be 2 mm or less, 1 mm or less, or 500 μm or less.

The solid electrolyte layer can be easily formed, for example, by dry or wet shaping of a solid electrolyte composite material containing the above-described solid electrolyte, binder, and others.

### Electrolyte Layer-Electrolytic Solution

The lithium-ion secondary battery in the present disclosure may be a liquid-state battery, that is, may include an electrolytic solution, particularly, an electrolytic solution held in a separator layer, as the electrolyte layer.

### Electrolytic Solution

The electrolytic solution is not particularly limited, and preferably should contain a supporting electrolyte and a solvent.

The supporting electrolyte (lithium salt) of the electrolytic solution having lithium-ion conductibility is not particularly limited, and there are an inorganic lithium salt, an organic lithium salt, and others. Examples of the inorganic lithium salt include LiPF₆, LiBF₄, LiClO₄, and LiAsF₆, but are limited to these. Examples of the organic lithium salt include LiCF₃SO₃, LiN(CF₃SO₂)₂, LiN(C₂F₅SO₂)₂, LiN(FSO₂)₂, and LiC(CF₃SO₂)₃, but are not limited to these.

The solvent that is used in the electrolytic solution is not particularly limited, and there are a cyclic carbonate, a chain carbonate, and others. Examples of the cyclic carbonate include ethylene carbonate (EC), propylene carbonate (PC), and butylene carbonate (BC), but are not limited to these. Examples of the chain carbonate include dimethyl carbonate (DMC), diethyl carbonate (DEC), and ethyl methyl carbonate (EMC), but are not limited to these. As the electrolytic solution, which is not particularly limited, only one kind may be used alone, or two or more kinds may be combined and used.

### Separator

The separator is not particularly limited, and a general separator for batteries can be appropriately employed. As the separator, for example, non-woven fabric composed of polyolefin, polyamide, polyimide, or the like can be used.

### Method of Producing Lithium-Ion Secondary Battery

A method of producing the lithium-ion secondary battery in the present disclosure is
a method of producing a lithium-ion secondary battery including an electrode active material layer, the method including:
   generating an electrode composite material by mixing two or more kinds of electrode active materials having different average particle diameters and a binder having an average particle diameter of 0.30 μm or more; and
   producing the electrode active material layer by shaping the electrode composite material, in which
the average particle diameter of an electrode active material having the largest average particle diameter is greater than or equal to five times the average particle diameter of an electrode active material having the smallest average particle diameter.

With the method in the present disclosure, it is possible to provide a lithium-ion secondary battery including an electrode active material layer that has a high binding force for a current collector layer, particularly, an electrode active material layer that has a high binding force for the current collector layer even when the electrode active material layer is produced by the high-speed drying of the electrode composite material slurry at a high temperature.

The method in the present disclosure includes generating an electrode composite material by mixing two or more kinds of electrode active materials having different average particle diameters and a binder having an average particle diameter of 0.30 m or more. As for the constitutions of the two or more kinds of electrode active materials having different average particle diameters and the binder, the above description about the lithium-ion secondary battery can be referred to.

The mixing amount of the electrode active material is not particularly limited. For example, when all (all solid content) of the electrode active material layer is 100 mass %, the mixing amount of the electrode active material may be 40 mass % or more, 50 mass % or more, or 60 mass % or more, and may be 100 mass % or less, or 90 mass % or less.

The mixing amount of the binder is not particularly limited. For example, the mixing amount of the binder may be 0.1 pts·mass or more, 0.2 pts·mass or more, 0.5 pts·mass or more, 1.0 pts·mass or more, or 2.0 pts·mass or more, and may be 5.0 pts·mass or less, 4.5 pts·mass or less, 4.0 pts·mass or less, 3.5 pts·mass or less, or 3.0 pts·mass or less, with respect to 100 pts·mass of the electrode active material.

The mixing method is not particularly limited, and for example, the mixing may be performed by a known method in which a V-shape rotating mixer or the like is used. It is preferable that two or more kinds of electrode active materials having different average particle diameters are uniformly mixed.

The electrode composite material may optionally contain a conduction aid, a solid electrolyte, and various additive agents or the like, in addition to the electrode active material and the binder. As for the constitutions of the conduction aid and the solid electrolyte, the above description about the lithium-ion secondary battery can be referred to.

The production method in the present disclosure includes producing the electrode active material layer by shaping the electrode composite material. As for the constitution of the electrode active material layer, the above description about the lithium-ion secondary battery can be referred to.

The shaping method for the electrode composite material is not particularly limited. For example, the electrode composite material in which a solvent is added may be applied on the current collector layer, and the electrode composite material may be dried at a temperature of 100° C. or higher.

The drying temperature may be 100° C. or higher, 110° C. or higher, 120° C. or higher, 130° C. or higher, 140° C. or higher, or 150° C. or higher, and may be 200° C. or lower, 190° C. or lower, 180° C. or lower, 170° C. or lower, or 160° C. or lower. The method for the drying is not particularly limited, and for example, hot-air drying, infrared ray drying, reduced-pressure drying, or dielectric heat drying may be adopted.

The method for the applying is not particularly limited, and for example, a doctor blade method, a die coating method, a gravure coating method, a spray applying method, an electrostatic applying method, or a bar applying method may be adopted.

The lithium-ion secondary battery in the present disclosure may include a positive electrode current collector layer, a negative electrode current collector layer, an electrolyte layer, and others, in addition to the electrode active material layer. The positive electrode current collector layer, the negative electrode current collector layer, the electrolyte layer, and others may be produced by known methods, respectively. As for the constitutions of the positive electrode current collector layer, the negative electrode current collector layer, the electrolyte layer, and others, the above description about the lithium-ion secondary battery can be referred to.

The present disclosure will be specifically described with examples and a comparative example. The present disclosure is not limited to these examples.

### Preparation of Electrode Composite Material Slurry

As the electrode active material, lithium cobalt oxide (LiCoO₂) was used. An electrode active material having the largest average particle diameter and an electrode active material having the smallest average particle diameter were mixed at mass ratios shown in Table 1. The electrode active material, styrene-butadiene copolymer (SBR) as a binding agent, and carboxymethyl cellulose (CMC) as a dispersing agent were weighed at a mass ratio of 95:4:1, were mixed with ion-exchange water, and were adjusted at a viscosity of 120 Pa·s (a shear rate of 0.1 s⁻¹), so that electrode composite material slurries in Examples 1 and 2 and Comparative Example 1 were prepared.

### Evaluation of Binding Force Between Electrode Active Material Layer and Current Collector Layer

As for each of the electrode composite material slurries in Examples 1 and 2 and Comparative Example 1, the electrode composite material slurry was applied on a copper foil surface as the current collector layer, such that the thickness was 420 μm. Then, an electrode body (low-speed drying) for which drying was performed at 50° C. for 20 minutes and an electrode body (high-speed drying) for which drying was performed at 150° C. for 2 minutes were prepared. In the electrode body (low-speed drying), the binder migration was sufficiently restrained.

Next, for each of the electrode body (low-speed drying) and the electrode body (high-speed drying), the peeling strength between the electrode active material layer and the current collector layer was measured. The peeling strength between the electrode active material layer and the current collector layer was measured by fixing a test sample of the current collector layer on which the electrode active material layer was laminated, to a base member in a 90° peeling tester, and peeling the electrode active material layer from one end portion, in accordance with JIS-K-6854-1.

Then, based on [peeling strength of electrode body (high-speed drying)]/[peeling strength of electrode body (low-speed drying)], a migration restraint degree was calculated, and the binding force between the electrode active material layer and the current collector layer was evaluated. A migration restraint degree of 1.0 means that the migration did not occur even in the case of the high-speed drying, and a migration restraint degree of less than 1.0 means that the migration occurred. The evaluation result is shown in Table 1.

TABLE 1

| | Example | Example | Comparative |
|---|---|---|---|
| | 1 | 2 | Example 1 |
| Average particle diameter of electrode active material | 10 | 10 | 10 |
| having largest average particle diameter | | | |
| Average particle diameter of electrode active material | 1 | 1 | — |
| having smallest average particle diameter | | | |
| [Average particle diameter of electrode active material | 10 | 10 | — |
| having largest average particle diameter]/[Average particle | | | |
| diameter of electrode active material having smallest | | | |
| average particle diameter] | | | |
| Mass ratio between electrode active material having largest | 8:2 | 7:3 | 10:0 |
| average particle diameter and electrode active material | | | |
| having smallest average particle diameter | | | |
| Pore diameter (μm) | 0.84 | 0.50 | 1.34 |
| Porosity (%) | 7.50 | 0.90 | 13.3 |
| Migration restraint degree | 1.0 | 1.0 | 0.8 |

As shown by Examples 1 and 2 and Comparative Example 1 in Table 1, when particles having small particle diameters are mixed in the electrode active material, the pore diameter and the porosity decrease. Moreover, it can be understood that the decrease in pore diameter and porosity prevents the occurrence of the binder migration even when the high-speed drying is performed after the electrode composite material slurry is applied.

What is claimed is:

1. A lithium-ion secondary battery including an electrode active material layer, wherein:
the electrode active material layer contains an electrode active material and a binder;
an average pore diameter of the electrode active material layer is 1.00 μm or less; and
a porosity of the electrode active material layer is 8.8% or less.

2. The lithium-ion secondary battery according to claim 1, wherein:
the electrode active material layer contains, as the electrode active material, two or more kinds of electrode active materials having different average particle diameters; and
an average particle diameter of an electrode active material having a largest average particle diameter is greater than or equal to five times an average particle diameter of an electrode active material having a smallest average particle diameter.

3. The lithium-ion secondary battery according to claim 1, wherein the average pore diameter of the electrode active material layer is 0.30 μm or more, and/or the porosity of the electrode active material layer is 0.5% or more.

4. A method of producing a lithium-ion secondary battery including an electrode active material layer, the method comprising:
generating an electrode composite material by mixing two or more kinds of electrode active materials having different average particle diameters and a binder having an average particle diameter of 0.30 μm or more; and
producing the electrode active material layer by shaping the electrode composite material, wherein
an average particle diameter of an electrode active material having a largest average particle diameter is greater than or equal to five times an average particle diameter of an electrode active material having a smallest average particle diameter.

5. The method according to claim 4, further comprising drying the electrode composite material at a temperature of 100° C. or higher.
